(19) United States
(12) Patent Application Publication
(10) Pub. No.: US 2008/0195763 A1
(43) Pub. Date: Aug. 14, 2008

(54) Method and Device for Transmitting Data on a Data Line Between a Control Device and a Decentralized Data Processing Device

(75) Inventor: Wolfgang Gottswinter, Regensburg (DE)

Correspondence Address: LERNER GREENBERG STEMER LLP, P O BOX 2480, HOLLYWOOD, FL, 33022-2480, US

(73) Assignee: SIEMENS VDO AUTOMOTIVE AKTIENGESELLSCHAFT, Regensburg (DE)

(21) Appl. No.: 11/910,276

(22) PCT Filed: Mar. 31, 2006
(86) PCT No.: PCT/EP06/61208

§ 371 Date: Oct. 1, 2007

(30) Foreign Application Priority Data
Mar. 31, 2005 (DE) DE102005014782.8

(51) Int. Cl. G06F 3/00; G06F 1/04

(52) U.S. Cl. 710/8; 710/1; 713/375

(57) ABSTRACT

A method for transmitting data to a data line between a central control device and a decentralized data processing device. Input data of the decentralized data processing device is supplied to a processing unit of the decentralized data processing device in a first resolution. The processing unit carries out a transformation of the input data according to a calculation rule, and transmits the transformed data to the central control device by way of the data line in a second resolution. The central control device is used to determine, in the framework of a configuration of the decentralized data processing device, according to which calculation rule from a plurality of calculation rule, the decentralized data processing device is to carry out the transformation.

The invention relates to a method and an arrangement for transmitting data on a data line between a central control device and a decentralized data processing device.

An arrangement of the above-mentioned type is used, for example, in the field of occupant protection in motor vehicles. In the case of an application in the field of occupant protection, the central control device is a centrally arranged central control device of an occupant protection system, which is also called an electronic control unit (ECU). In the case of the decentralized data processing device, which is also called a satellite, it is a decentralized sensor unit connected to the central control device. In order to detect a side-on collision, sensor measured values from at least one data processing device disposed in the area of the doors or mudguards, and an acceleration signal measured in the central control device are taken into account in an algorithm running in the control device and evaluated there according to defined criteria.

A data processing device used in an occupant protection system typically comprises a sensor device, an A-D converter as well as a processing unit connected to said A-D converter. The sensor signal emitted by the sensor device is converted by the A-D converter and supplied to the processing unit, which carries out filtering and transmission of the sensor measured values with a linear transmission curve to the central control device via the data line. The sensor device captures a relatively large acceleration range whose resolution precision for the evaluation by the central control device depends on the transmission data width of the data line. In practice, the transmission data width is relatively small in the case of transmission via the data line, whereby this is typically 7 bits. Typical sensor devices are designed for an acceleration range of ±40 g, ±125 g or ±250 g, whereby the resolution precision at the same transmission data width decreases with an increasing acceleration range.

A method and a device for transmitting data on a data line between a control device and a decentralized data processing device are known from DE 196 09 290 A1. In the latter a sensor module for use in a motor vehicle is described, said sensor module being connected to a central control device via a data line. The sensor module comprises an acceleration-sensitive sensor and periodically, every 500 μs, transmits an encoded data packet, processed from the sensor measured values of the sensor by way of current modulation, to the control device, as soon as it has detected on the data line a synchronization voltage pulse generated by the central control device.

The sensor module is connected to an interface of the control device via a two-wire line. The communication between the control device and the sensor module is bidirectional which enables signal transmission both from a sensor module to the control device and also vice versa. This makes it possible to configure the sensor module during the manufacture of the motor vehicle, when it is commissioned or also subsequent to a repair due to an accident, by activating the sensor module using the control device.

According to a first proposal, the communication between the control device and the sensor module is achieved by lowering a voltage value on the data line between the control device and the sensor module from an initially higher value to a lower value. The voltage lowering occurs at a point in time T1 and lasts until a point in time T2. At this point in time T2 the voltage is raised from the lowered value back up to the original value. Voltage control of this kind can be repeated cyclically. The duration of the voltage lowering can be detected by the sensor module, whereby, by means of the temporal difference between the points in time T2 and T1 the sensor module can detect whether a specific control signal of the control device is present or not. According to a second proposal, the communication envisages emitting a control signal consisting of several voltage fluctuations, which control signal contains information for the sensor module in encoded form.

DE 196 09 290 A1 gives no information as to the precision with which the measured values can be transmitted from the sensor module to the control device, and this determines the precision and hence the reliability of such a sensor arrangement.

It is, therefore, the object of this invention, to create a possibility in a sensor arrangement, which allows a high degree of precision and reliability when evaluating the data supplied by a data processing device and wherein identically constructed data processing devices can be used, whereby this should be done using the least possible circuitry resources.

This object is achieved using a method with the features as claimed in claim 1 and an arrangement with the features of claim 12. Advantageous embodiments result from the dependent claims.

In the method according to the invention for transmitting data on a data line between a central control device and a decentralized data processing device, input data of the decentralized data processing device is supplied to a processing unit of the first decentralized data processing device in a first resolution. The data processing unit carries out a transformation of the input data according to a calculation regulation (BVi), and transmits the transformed data to the central control device by means of the data line in a second resolution. The central control device is used to determine, in the framework of a configuration of the decentralized data processing device, according to which calculation regulation (BVi) from a plurality of calculation regulations, the decentralized data processing device is to carry out the transformation.

In this way a variation of the second resolution adapted to the situation is realized. The transformation of the input data from the first into the second resolution does not necessarily have to be carried out in a linear fashion. Rather, the calculation regulation can be developed in such a way that a non-linear transformation occurs. Thereby the transformation can follow segment by segment in a different linear and/or quadratic fashion and/or follow the course of any conversion function.

Thereby the invention is based on the knowledge that when the data processing device captures acceleration values the critical acceleration range is in a low g-range. In the low g-range, which is specific to different motor vehicles and is dependent on the location at which the data processing device is installed, e.g. in a motor vehicle, the danger of misinterpretations by the control device, and in particular the danger of an occupant protection systems being erroneously triggered, is particularly great, as the sensor measured values can either be due to the impact of an actual collision object, which would, for example, require an occupant protection system to be triggered, or it could be caused by a different kind of collision object which does not require a protection system to be triggered. For the analysis it is, therefore, helpful, to provide the central control device with data that has a high resolution in the low g-range. In contrast, in the upper g-range, in principle, one can assume that a detected impact is caused by another motor vehicle and the occupant protection system must be triggered. Therefore, in this range the resolution of the data supplied to the central control device can be coarser.

In order to be able to provide the central control device with data with optimized significance, regardless of the transmission data width of the data line, the invention thus proposes to submit not only, but in particular the ranges that are especially relevant for the analysis to be carried out by the control device to a suitable transformation in the data processing device and not to transform the less relevant ranges or to transform them differently. Hereby the information about the transformation(s) is stored in a calculation regulation, which carries out the relevant transformation(s). So that the arrangement can be adapted flexibly to the conditions, it is further provided that the calculation regulation is variable, whereby the central control device determines which calculation regulation the data processing device must use for the transformation.

According to a development of this invention, the central control device undertakes an inverse transformation of the data received using the calculation regulation employed by the decentralized data processing device for the transformation. In this way the central control device can take into account the “changes” which the data processing device caused by the transformation.

According to a further embodiment, a plurality of calculation regulations are stored along with respective calculation regulation identifiers in the decentralized data processing device. In the framework of the configuration, a calculation regulation identifier is transmitted from the central control device to the decentralized data processing device. This procedure renders the configuration of the data processing device particularly simple as the complex calculation regulation, which can be potentially very big, does not have to be transmitted from the central control device to the data processing device, and only a reference to the calculation regulation to be used is transmitted.

According to one design, the calculation regulations contain characteristic curves on the conversion of the first resolution into the second resolution. Thereby the characteristic curves can have segments with different resolutions.

According to a further embodiment, the calculation regulation determined by the central control device in the framework of the configuration depends on the data to be determined by the decentralized data processing device and on the ambient conditions to which the decentralized data processing device is exposed. The data to be determined are preferably acceleration values, whereby the acquisition of the data is dependent on the location of usage or of installation of the data processing devices, e.g. in a motor vehicle.

In one embodiment, during its initialization, the decentralized data processing device is configured by the central control device with respect to the calculation regulation to be used. The initialization is carried out, for example, each time after the arrangement is switched on, thereby, the control device can carry out the configuration in a suitable way at every initialization. In addition this procedure has the advantage that when a faulty data processing device is replaced by a data processing device that is identical in construction, no further arrangements need to be made with respect to its programming or configuration, as, every time the arrangement is switched on, the configuration is carried out automatically and completely when an initialization routine is run through.

In a further embodiment, during a normal operation, the central control device periodically emits synchronization pulses via the data line to the at least one data processing device in order to request data packets and, following the synchronization pulse, the decentralized data processing device sends the data it has waiting to be transmitted, to the central control device as a data packet, whereby, for the configuration of the decentralized data processing device, a communication is made from the central control device to the decentralized data processing device and the synchronization pulses are used as information carriers.

For the configuration of the data processing device, a bi-directional communication takes place between the control device and the data processing device. The use of the synchronization pulses as information carriers and the analysis of said pulses by the data processing device saves having to provide special send circuits in the central control device. Only one unit needs to be provided which, according to the configuration information to be encoded, triggers a synchronization pulse generator to generate synchronization pulses or not to do so. Thereby the time interval and the pulse-pause relation of the synchronization pulses can be selected according to the later normal operation.

The decentralized data processing device is preferably a sensor unit and the data packets transmitted by said decentralized data processing device to the central control device contain sensor measured values. The synchronization pulse is output as a voltage pulse, whereas the data packets of the decentralized data processing devices are sent as current pulses.

The arrangement according to the invention has the same advantages as were described above in connection with the method, and is characterized by the fact that it can be used for the performance of a method as described above.

The invention is explained in more detail below using the figures, in which;

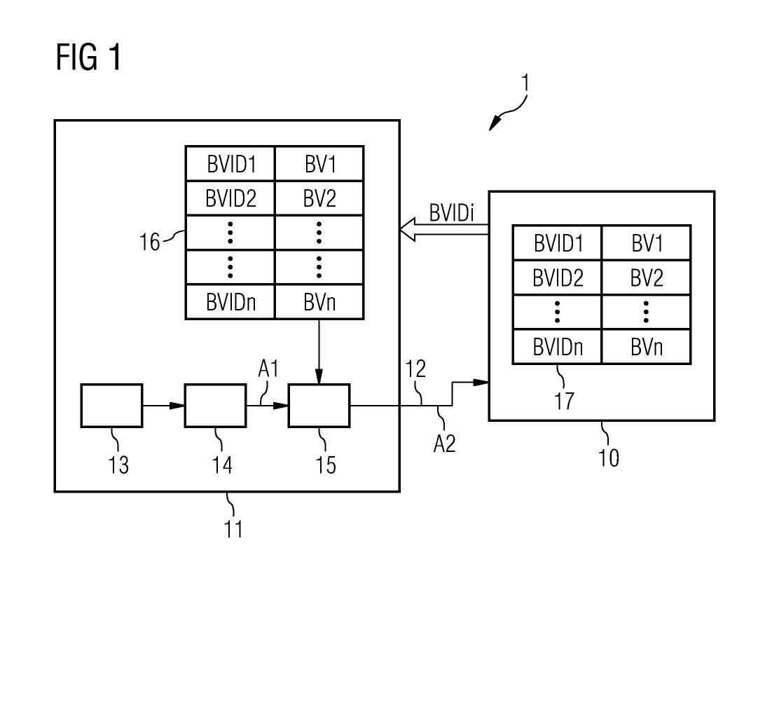

FIG. 1 shows the schematic structure of an arrangement for transmitting data on a data line between a central control device and a decentralized data processing device,

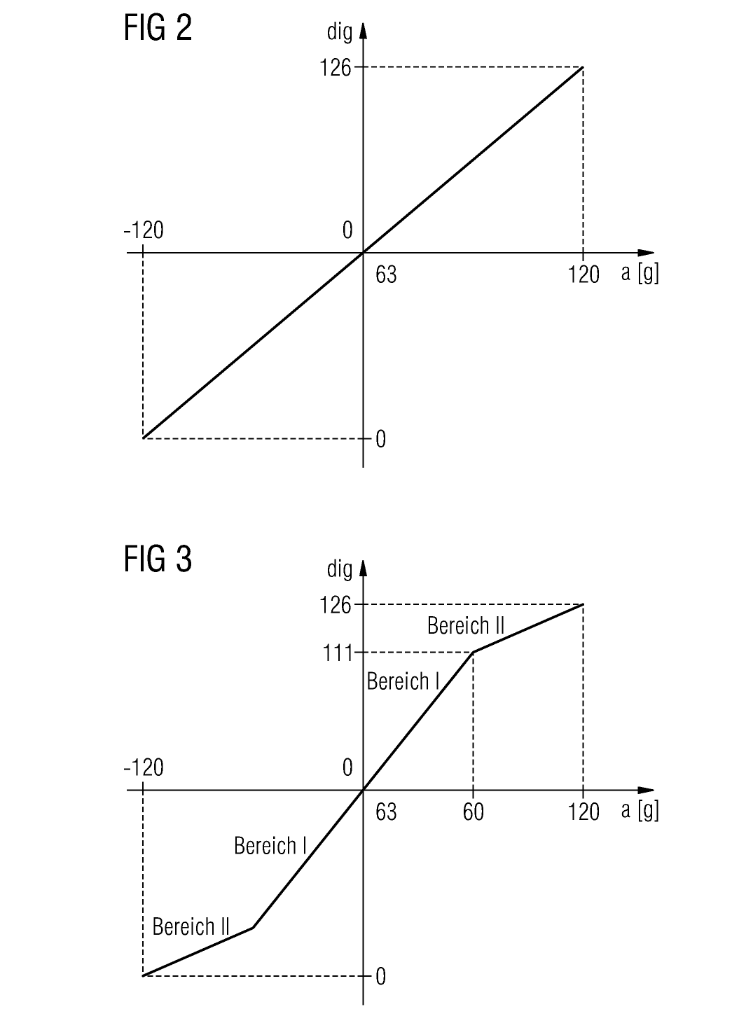

FIG. 2 to 4 show examples of different transmission characteristics for influencing the resolution of the data to be transmitted to the control device, and

FIG. 5 shows a further schematic structure of an arrangement, from which the problematic in the transmission of data can be seen.

FIG. 5 shows a sensor arrangement 1 with a central control device 10, which is connected with a decentralized data processing device 11 via a data line 12. An arrangement of this kind could be, for example, part of an occupant protection system in a motor vehicle. The data processing device 11 comprises a sensor device 13, which supplies the sensor measured values determined by it to an A-D converter 14. After analogue-digital conversion, the sensor measured values are supplied to a processing unit 15, which undertakes filtering and transmits the data to the central control device 10 using a preset transmission curve via an interface and the data line 12.

The signal resolution, with which the data can be transmitted to the central control device, is hereby made up of the resolution of the sensor device, of the resolution of the A-D converter and of the transmission data width of the data line 12. The signal resolution is calculated according to the formula

$$\frac{sensor \cdot resolution ⌊ \frac{mV}{g} ⌋}{voltage \cdot range\_ofthe \_AD \_converter} \cdot transmission \cdot data \cdot width$$

For example, the sensor device 13 is a 125 g-acceleration sensor with a resolution of 18 mV/g. If the A-D converter 14 is designed as a 5 V A-D converter with a data width of 10 bits and if the data width of the data line 12 is 7 bits, according to the above formula, a resolution of 3.69 dig/g results when the data is transmitted from the A-D converter 14 to the processing unit 15, whereas the resolution is only 0.46 dig/g when the transmission is made via the data line 12. Since not all acceleration ranges are of equal interest for the analysis of the data transmitted to the central control device 10, the resolution can be too low in one range while it is much too high for another range.

In order to combat this problem, the invention proposes a variable transmission characteristic of the data transmitted via the data line 12. To this end, the data processing device 11 has, as shown in FIG. 1, a plurality of calculation regulations BV1, BV2, . . . , BVn (hereinafter BVi), to which respectively a calculation regulation-identifier BVID1, BVID2, . . . , BVIDn (hereinafter BVIDi) is assigned. The calculation regulations BVi contain a characteristic curve for a transmission of the data via the data line. During the initialization of the data processing device 11 by the central control device 10, one of these calculation regulations for influencing the later data transmission can be selected.

Expediently not the calculation regulations themselves but just the desired calculation regulation identifier BVIDi is transmitted to the decentralized data processing device via the data line 12, so that said decentralized data processing device can select the assigned calculation regulation BVi with the help of the calculation regulation identifier BVIDi. To this end the calculation regulations are located in a memory 16 of the data processing device 11 and are likewise kept for a later inverse transformation of the transformed data in the central control device 10 in a memory 17. Which of the calculation regulations stored in a data processing device 11 is chosen for the transformation of the first resolution into a second resolution by the control device depends on the location of installation and the application of the data processing device.

FIG. 2 shows a first exemplary embodiment of a calculation regulation in the form of a linear characteristic curve where there is a second resolution of 0.525 dig/g over the entire acceleration range of −120 to +120 g. Thereby the processing unit 15 converts the data supplied to it in a first resolution into the second resolution and transmits the transformed data to the control device.

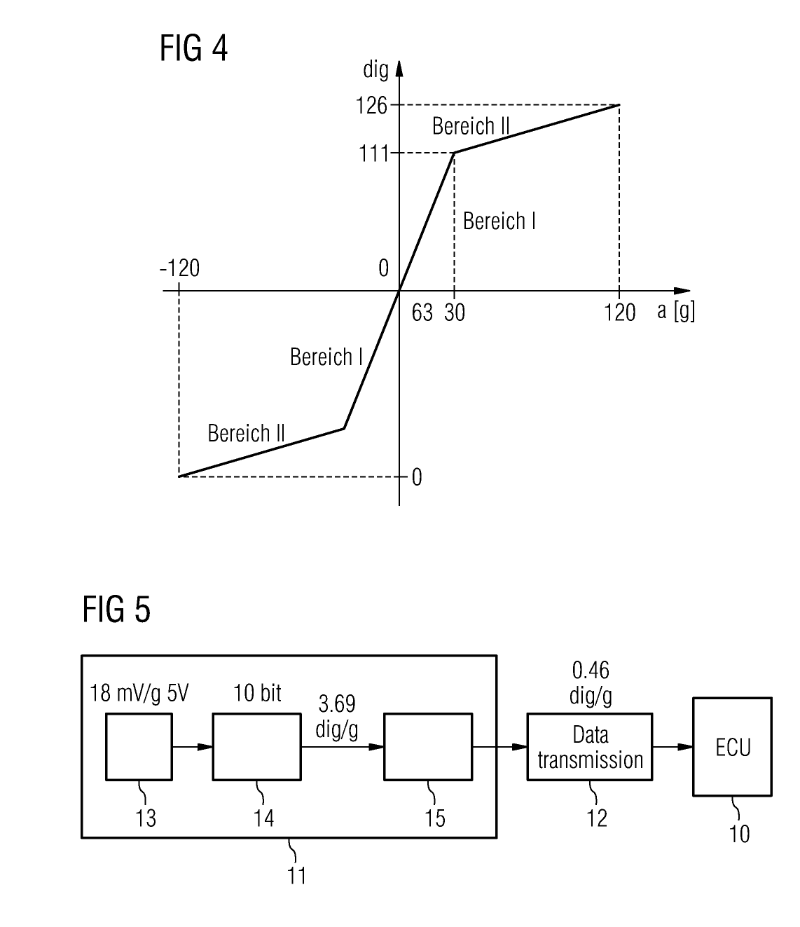

In the second and third exemplary embodiment according to FIGS. 3 and 4, the calculation regulations in the form of a characteristic curve each have two segments with varying rate of rise, which results in varying second resolutions. The resolution for Range I is 0.8 dig/g, which applies for the detection of acceleration values in the range −60 g to +60 g. In Range II the measured values determined by the sensor device are transmitted to the central control device with a resolution of 0.25 dig/g.

In the exemplary embodiment according to FIG. 4 there results a resolution of 1.6 dig/g (for accelerations of −30 g to +30 g) for Range I and a resolution of 0.167 dig/g for Range II.

This means that accelerations in the lower g-range (Range I) are transmitted with a very high resolution to the central control device via the data line 12, enabling said control device to make a more refined decision as to the triggering of a protection system. In the upper g-ranges (Range II) in contrast, the sensor measured values are transmitted with a low resolution, as there in principle one can assume an impact, whereby the central control device can output a corresponding trigger signal to a protection system.

Contrary to the embodiments presented, the segments of the characteristic curve do not necessarily have to be linear, but can also develop e.g. quadratically. In principle, any course of a characteristic curve that can be stored in a calculation regulation is conceivable.

In one variant it would also be conceivable to store the calculation regulations not in the data processing device, but exclusively in the central control device and to transfer said calculation regulations completely during the configuration. This would make a later change of configurations simpler, as only the contents in the central control device, but not in the data processing device, need to be adapted.

The configuration of the data processing devices 11 can be carried out using the components used so far (control device and data processing device). The configuration, which preferably takes place in an initialization phase of the arrangement, can be carried out using software. The choice of configuration for a desired application is flexible. In particular, the replacement of faulty data processing devices is simplified, as the control device reconfigures the data processing devices every time it is initialized. In principle, the possibility is also given to change the configuration during the operation of the arrangement.

The data processing device is configured using the synchronization pulses emitted by the central control device in normal operation. During the initialization phase the presence or absence of the periodically sent synchronization pulses can be assessed by the data processing device in order to use this to select the desired calculation regulation or characteristic curve.

1-12. (canceled)

13. A method of transmitting data on a data line between a central control device and a decentralized data processing device, the method which comprises:
supplying input data of the decentralized data processing device to a processing unit of the decentralized data processing device in a first resolution;
carrying out a transformation, in the processing unit, of the input data according to a calculation rule, and transmitting transformed data to the central control device by way of the data line in a second resolution; and
determining with the central control device, within a configuration of the decentralized data processing device, according to which calculation rule from a plurality of calculation rules, the decentralized data processing device is to carry out the transformation.

14. The method according to claim 13, which comprises carrying out, with the central control device, an inverse transformation of the received data using the calculation rule used by the decentralized data processing device for the transformation.

15. The method according to claim 13, wherein a plurality of calculation rules are stored in the decentralized data processing device together with respective calculation rule identifiers, and wherein the configuration of the decentralized data processing device includes transmitting a calculation rule identifier from the central control device to the decentralized data processing device.

16. The method according to claim 13, wherein the calculation rules contain characteristic curves on a conversion of the first resolution into the second resolution.

17. The method according to claim 16, wherein the characteristic curves have segments with varying resolutions.

18. The method according to claim 16, wherein the calculation rule determined by the central control device within a framework of the configuration depends on the data to be determined by the decentralized data processing device and on ambient conditions to which the decentralized data processing device is exposed.

19. The method according to claim 13, which comprises configuring the decentralized data processing device with the central control device during an initialization with respect to the calculation rule to be used.

20. The method according to claim 13, wherein, during normal operation, the central control device periodically emits synchronization pulses via the data line to the at least one data processing device in order to request data packets and, following the synchronization pulse, the decentralized data processing device sends the data available to be transmitted, to the central control device as a data packet, and wherein, for the configuration of the decentralized data processing device, a communication is made from the central control device to the decentralized data processing device and the synchronization pulses are used as information carriers.

21. The method according to claim 20, wherein the decentralized data processing device is a sensor unit and the data packets transmitted by the decentralized data processing device to the central control device contain sensor measured values.

22. The method according to claim 20, which comprises emitting the synchronization pulse in the form of a voltage pulse.

23. The method according to claim 20, which comprises transmitting the data packets of the decentralized data processing device in the form of current pulses.

24. An assembly configured to execute the method for transmitting data according to claim 13.
